(19) United States
(12) Patent Application Publication
(10) Pub. No.: US 2008/0124606 A1
(43) Pub. Date: May 29, 2008

(54) STRETCHED PROTON EXCHANGE MEMBRANE

(76) Inventors: Jun Lin, Beachwood, OH (US); Ryszard Wycisk, Shaker Heights, OH (US); Peter N. Pintauro, Shaker Heights, OH (US)

Correspondence Address: TAROLLI, SUNDHEIM, COVELL & TUMMINO, LLP, 1300 EAST NINTH STREET, SUITE 1700, CLEVELAND, OH, 44114, US

(21) Appl. No.: 11/937,812

(22) Filed: Nov. 9, 2007

Related U.S. Application Data
(60) Provisional application No. 60/858,055, filed on Nov. 10, 2006.

(51) Int. Cl. H01M 8/10; C08G 75/00; B29C 39/00

(52) U.S. Cl. 429/33; 521/27; 429/30; 264/291

(57) ABSTRACT

A proton exchange membrane includes a semi-permeable polyelectrolyte films that extends along an axis. The polyelectrolyte film is stretched along the axis and remains stretched when immersed in a methanol or methanol and water solutions.

### RELATED APPLICATION

This application claims priority from U.S. Provisional Application No. 60/858,005, filed Nov. 9, 2006, the subject matter, which is incorporated herein by reference.

### FIELD OF THE INVENTION

The present invention relates to a proton exchange membrane, and more particularly, to a method of forming a proton exchange membrane.

### BACKGROUND OF THE INVENTION

A direct methanol fuel cell (DMFC) includes a proton exchange membrane (PEM) that separates an anode compartment, where oxidation of the fuel (i.e., methanol) occurs, and a cathode compartment, where reduction of an oxidizer occurs. The anode and cathode are essentially constituted by a porous support, such as a porous carbon support, on which particles of a noble metal (e.g., platinum) are deposited. The PEM typically provides a conduction medium for protons from the anode to the cathode as well as provides a barrier between the fuel and the oxidizer.

Membrane permeation of methanol during DMFC operation results in a power loss due to: (i) chemical oxidation of methanol at the cathode, causing electrode depolarization and unwanted consumption of O₂, (ii) poisoning of the cathode by CO, an intermediate of methanol oxidation, and (iii) excessive water build-up at the cathode (water being produced by methanol oxidation) which limits O₂ access to cathode catalyst sites (i.e., flooding). Additionally, the overall fuel utilization efficiency of the fuel cell is lowered when there is excessive methanol crossover.

DuPont's NAFION is the membrane material of choice for moderate temperature hydrogen/air fuel cells, but it does not perform well in a DMFC due to high methanol crossover. Many new polymeric materials have been investigated as potential methanol blockers, including sulfonated derivatives of polyphosphazene, poly(ether ketone), polysulfone, and polyimide; phosphoric acid doped polybenzimidazole; radiation grafted polymers; and polymer blends/composites. Another approach has been to modify NAFION membranes by addition of a methanol barrier component, such as the incorporation of inorganic particles (e.g., silicon oxide, titanium oxide, zeolites and montmorillonite clay), impregnation of NAFION with poly(1-methylpyrrole), and blending with poly(vinylidene fluoride). In most studies, low methanol permeability could only be achieved at the expense of proton conductivity, which necessitated the use of thin membranes (to maintain a low membrane sheet resistance), thus partially or completely negating the intrinsic barrier properties of the low methanol permeation materials.

### SUMMARY OF THE INVENTION

The present invention relates to a proton exchange membrane (PEM) that can be used in a direct methanol fuel cell. The PEM comprises a semi-permeable polyelectrolyte film that extends along an axis. The polyelectrolyte film is stretched along the axis and remains stretched when immersed in methanol or a methanol/water solution. The proton exchange membrane has reduced methanol crossover (i.e., methanol permeability) and equal or better power output compared to commercially available proton exchange membranes. The PEM can have a thickness of about 10 μm to about 200 μm, for example, about 50 μm to about 180 μm.

In an aspect of the invention, the polyelectrolyte film has a first methanol permeability in an unstretched configuration and a substantially reduced methanol permeability in the stretched configuration. The polyelectrolyte film also has a first proton conductivity in an unstretched configuration and a substantially equal or increased proton conductivity in the stretched configuration.

In another aspect of the invention, the polyelectrolyte includes a perfluorosulfonic acid polymer, such as NAFION, which is commercially available from Ion-power Inc. (New Castle, Del.). The polyelectrolyte can also include other polymers or blends of polymers typically used in forming a proton exchange membrane. Example of such polymers are sulfonated derivatives of polyphosphazene, poly(ether ketone), polysulfone, polyetetrafluoroethylene, and polyimide.

The present invention also relates to a method of forming a proton exchange membrane. In the method, a semi-permeable polyelectrolyte film is formed that extends along an axis. The polyelectrolyte film is stretched along the axis. The stretched film remains in a stretched configuration upon exposure to methanol or a methanol and water solution.

In an aspect of the invention, the polyelectrolyte film can be formed by solution casting the polyelectrolyte film and then partially drying the polyelectrolyte film. In another aspect of the invention, following stretching, the polyelectrolyte film can be annealed and then activated by boiling the stretched, annealed polyelectrolyte film in an acidic solution

### BRIEF DESCRIPTION OF THE DRAWINGS

Further features of the present invention will become apparent to those skilled in the art to which the present invention relates from reading the following description of the invention with reference to the accompanying drawings in which:

FIG. 1 is a schematic illustration of a fuel cell in accordance with an aspect of the invention.

FIG. 2 illustrates a plot of the through-plane proton conductivity (in water at 25° C.) and methanol permeability (1.0 M methanol at 60° C.) of stretched recast NAFION membranes as a function of draw ratio.

FIG. 3 illustrates a plot of WAXS patterns of nonstretched and stretched recast NAFION films.

FIG. 4 illustrates DMFC polarization plots of MEAs containing nonstretched recast NAFION and stretched recast NAFION. 1.0 M methanol at 1.5 mL/min, 60° C., ambient pressure air at 500 sccm, 4 mg/cm² catalyst loading for the anode and cathode. Nonstretched recast NAFION, 200 μm wet thickness, open-circuit methanol crossover flux=1.25×10−5 mol/cm²-min; 3 layers of stretched recast NAFION, draw ratio of 4 with a total wet thickness of 180 μm; open-circuit methanol crossover flux=0.83×10−5 mol/cm²-min.

FIG. 5 illustrates fuel cell polarization curves at 0.5 M methanol for NAFION 117 and stretched recast NAFION (draw ratio of 4; three layers with a total thickness of 180 μm). Methanol feed at the optimized methanol flow rate at 10 mL/min for NAFION 117 and stretched recast NAFION. T=60° C.; ambient pressure air at 500 sccm; 4 mg/cm² catalyst loading for the anode and cathode.

FIG. 6 illustrates fuel cell polarization plots at 1.0 M methanol for NAFION 117 and stretched recast NAFION (draw ratio of 4; three layers with a total thickness of 180 μm). Methanol feed at the optimized methanol flow rate of 3 mL/min for NAFION 117 and 5 mL/min for stretched recast NAFION. T=60° C.; ambient pressure air at 500 sccm; 4 mg/cm² catalyst loading for the anode and cathode.

FIG. 7 illustrates plots of the effect of temperature (60° C. v. 80° C.) on DMFC performance for NAFION 117 and stretched recast NAFION (draw ration of 4; three layers with a total thickness of 180 μm). 1.0 M methanol feed at 1.5 mL/min; ambient pressure air at 500 sccm; 4 mg/cm² catalyst loading for the anode and cathode

FIG. 8 illustrates DMFC power density v. current density plots for NAFION 117 and stretched recast NAFION draw ration of 4; three layers with a total thickness of 180 μm) at 60° C. and 80° C. 1.0 M methanol feed at 1.5 mL/min; ambient pressure air at 500 sccm; 4 mg/cm² catalyst loading for the anode and cathode.

### DETAILED DESCRIPTION

The present invention relates to a proton exchange membrane (PEM). The PEM functions as an ion exchange electrolyte when used in a fuel cell.

A direct methanol fuel cell produces energy according to the equations shown below.

At the anode:

CH₃OH+H₂O═CO₂+6H⁺+6e⁻

At the cathode:

1.5O₂+6H⁺+6e⁻=3H₂O

Methanol is used as fuel in a direct methanol fuel cell. The methanol is oxidized at the anode. This electro-oxidation at the anode produces carbon dioxide, electrons, and protons. Electrons are conducted through the external load and are captured at the cathode. The oxidant, i.e., protons, are transported directly across the polymer electrolyte membrane to the cathode. Thus a flow of current is maintained by a flow of protons through the membrane of the fuel cell and a flow of electrons through the external load. However, fuel crossover from the anode through the membrane to the cathode can occur which lowers the operating potential of the cathode and represents consumption of fuel without production of useful electrical energy. Thus fuel crossover lowers efficiency and electrical performance of the fuel cell.

Hence the main functions of the proton exchange membrane include preventing the molecular forms of fuel and oxidant from mixing, and providing a means for ionic transport. It must also ensure that electrons pass from the fuel to the oxidizing electrode only via the external current.

The PEM of present invention comprises a semi-permeable stretched polyelectrolyte film. By “semi-permeable”, it is meant that the polyelectrolyte film includes a plurality of small pores that allow certain molecules, such as protons or ions, to pass through it but prevent larger molecules from passing through. By “stretched”, it is meant that the polyelectrolyte film is physically extended or elongated in at least one dimension after formation (e.g., casting) of the film and the extension or elongation is substantially permanent. By “substantially permanent”, it is meant that the stretched polyelectrolyte film when immersed in a methanol or methanol and water solution that is maintained at an elevated temperature (e.g., about 60° C.) retains its stretched extension or elongation.

In an aspect of the invention, the stretched polyelectrolyte film can include a first surface and a second surface separated from and opposite to the first surface. The first surface and the second surface of the polyelectrolyte film can extend substantially parallel to or along an axis.

The stretched polyelectrolyte film can be formed from at least one polymer that is capable of being stretched once formed and that includes an electrolyte group. In an aspect of the invention, the polymer can include a thermoplastic polyelectrolyte that can be readily cast by solution casting or melt casting techniques. An example of thermoplastic polymer that can be solution cast is NAFION. NAFION is a thermoplastic perfluorosulfonic acid polymer that is commercially available from Ion-power Inc. (New Castle, Del.).

By way of example, a NAFION solution (e.g., Liquion 1100 from Ion Power, Inc.) can be dissolved in a solvent, such as dimethyacetimide, at room temperature (e.g., about 25° C.) and cast in a dish (e.g., Teflon dish). The solvent can then be at least partially evaporated to produce a film having a thickness of about 200 μm to about 400 μm.

The polyelectrolyte can include other thermoplastic polymers or blends of polymers typically used in forming a PEMs. Example of such polymers are sulfonated derivatives of polyphosphazene, poly(ether ketone), polysulfone, polyetetrafluoroethylene, and polyimide.

The polyelectrolyte film once formed (e.g., by casting) is stretched in one dimension to substantially extend or elongate as well as reduce the thickness of the film. In an aspect of the invention, the polyelectrolyte film can be stretched along the axis (i.e., uniaxially stretch the film) to elongate the film and reduce the thickness of the film. Elongation and reduction of thickness of the film is believed to result in a change of morphology of the film. This change in morphology substantially reduces the methanol permeability of the film while maintaining or increasing the proton conductivity of the film.

The polyelectrolyte film can be stretched by, for example, heating (e.g., about 125° C.) and drawing the solvent swollen cast film to a given draw ratio. The draw ratio is defined as the final membrane length divided by its initial length. The draw ratio, which the polyelectrolyte film is stretched, can be any draw ratio that is effective to decrease the methanol permeability of the polyelectrolyte film while substantially maintaining or increasing the proton conductivity of the film. By way of example, the draw ratio can range from about 2.0 to about 7.0.

The stretched polyelectrolyte film can be then be maintained in a stretching frame for a duration of time and at a temperature effective to allow the film to dry (i.e., evaporate the solvent) or set. By way of example, the stretched solvent swollen film can be maintained on the stretching frame at a temperature of about 125° C. for about one hour to fully evaporate the solvent (e.g., DMAc).

The stretched polyelectrolyte film can then be annealed for a duration of time and at a temperature effect to maintain the stretched film in the substantially permanent elongated or extended shape. The annealing temperature and time is dependent on the particular polyelectrolyte used in forming the film. Where the polyelectrolyte film is formed from NAFION, the stretched NAFION film can be annealed at a temperature of about 150° C. for about 2 hours.

The stretched and annealed polyectrolyte film can then be conditioned and activated by boiling the stretched polyelectrolyte film in an acidic solution (e.g., 1.0 M H₂SO₄).

The stretched polyectrolyte film can be used alone as the PEM in a direct methanol fuel cell or layered with other stretched polyelectrolyte films to form the PEM. The PEM can have a thickness of about 10 μm to about 200 μm, for example, about 50 μm to about 180 μm.

The present invention also provides a novel fuel cell that makes use of a proton exchange membrane comprising the stretched and annealed polyelectrolyte film.

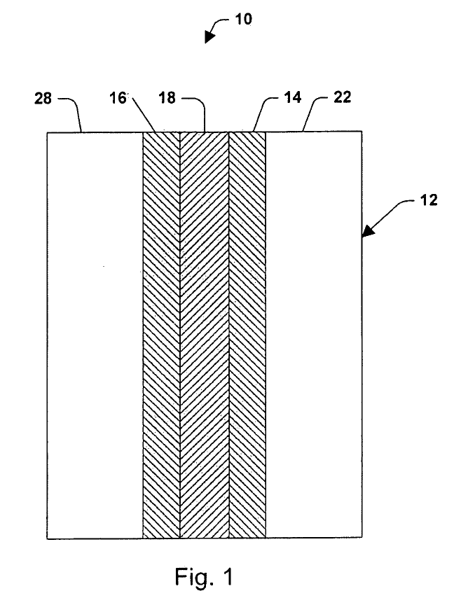

FIG. 1 shows a fuel cell 10 comprising a housing 12, an anode 14, a cathode 16 and a proton exchange membrane 18. The anode, cathode and membrane can be integrated to form a single composite structure, with the proton exchange membrane being interposed between the two electrodes, referred to as a membrane electrode assembly (MEA). The anode can include a carbon-supported Pt—Ru catalyst and the cathode have carbon-supported Pt. A pump (not shown) can circulate an aqueous solution of an organic fuel in the anode compartment 22 of housing 12. Carbon dioxide formed at the anode may be vented via an outlet port (not shown). The fuel cell is also provided with an oxygen or air compressor (not shown) to feed oxygen or air into the cathode compartment within housing 12.

Prior to operation, an aqueous solution of the organic fuel, such as methanol, can introduced into an anode compartment 22 of the fuel cell while oxygen or air is introduced into the cathode compartment 28. Next, an electrical load is connected between anode 14 and cathode 16. At this time, the organic fuel is oxidized at the anode and leads to the production of carbon dioxide, protons and electrons. Electrons generated at anode 14 are conducted via the external load to cathode 16. The protons generated at anode 14 migrate through proton exchange membrane 18 to cathode 18 and react with oxygen and electrons (which are transported to the cathode via the external load) to form water.

### EXAMPLE

In the present study, we report on a new DMFC membrane prepared from uniaxially stretched recast NAFION. The method of membrane fabrication is described, transport data are presented, and fuel cell performance is compared to that of commercial NAFION 117.

### Experimental

Membrane fabrication.—PEMs were prepared from NAFION polymer that was recovered after evaporating the solvent from a commercial NAFION solution (Liquion 1100 from Ion Power, Inc.). The dried NAFION material was fully dissolved in dimethylacetimide (DMAc) at room temperature and membranes were cast into a Teflon dish from the resulting 5 wt % solution. DMAc solvent was partially evaporated at 60° C., resulting in a film that was 200-400 μm in thickness. After the DMAc-swollen membrane was removed from the casting dish, it was heated to 125° C. and stretched uniaxially to a given draw ratio, ranging from 2.0 to 7.0 (where the draw ratio is defined as the final membrane length divided by its initial length). The membrane was kept in the stretching frame and further heated (at 125° C.) for 1 h to fully evaporate the DMAc, followed by an annealing step at 150° C. for 2 h. Nonstretched recast NAFION membranes were prepared from the same casting solution. After film drying at 125° C., such membranes were removed from the Teflon casting dish and annealed at 150° C. for 2 h. All membranes examined in this study (NAFION 117, nonstretched recast NAFION, and stretched recast NAFION) were boiled in 1.0 M H₂SO₄ for 1 h and then stored in room-temperature deionized water until further use.

The wet thickness of the stretched recast membranes was 50-60 μm, whereas the nonstretched recast NAFION films had a wet thickness of 200 μm.

Proton conductivity.—Proton conductivity of water-equilibrated membrane samples at room temperature was measured using an ac impedance technique (Agilent 4338B millimeter, where all measurements were made at 1 kHz) with custom-build two-electrode through-plane and in-plane conductivity cells. The in-plane cell employed a single-sheet membrane sample. For the through-plane measurements, the cell utilized 8×8 mm platinized Pt electrodes. In order to minimize surface capacitance effects, membranes were stacked together in order to give a total thickness of approximately 1 mm. The precision of the in-plane technique was checked by carrying out preliminary measurements with a stack of NAFION 117 films; the in-plane and through-plane conductivities were found to be the same at 0.10 S/cm.

Methanol permeability.—Methanol permeability was measured at 60° C. in a two-compartment diffusion cell, where one compartment was filled with an aqueous 1.0 M methanol solution and the second (receiving) chamber was filled with deionized water. The permeability of methanol through a vertically positioned membrane sample was determined by collecting methanol concentration vs time data in the receiving compartment and then matching this data to a simple diffusion model, as described elsewhere.

Membrane swelling in water.—Equilibrium absorption of deionized water in membrane samples was determined at room temperature. The wet weight (W_{wet}) was measured immediately after removing excess water from the film surfaces. Membrane dry weight (W_{dry}) was obtained after drying at 120° C. for 1 h (until there was no further change in the weight of a sample). The wt % swelling was calculated by

$$\% swelling = \frac{{W}_{wet} - {W}_{dry}}{{W}_{dry}} \times 100$$

Wide-angle X-ray diffraction (WAXD).—WAXD measurements were carried out in a Rigaku diffractometer with Cu Kα radiation in a long fine focus mode.

DMFC tests.—Fuel cell current-density-voltage data were collected using a single-cell test station (Scribner Series 890B) with mass flow and temperature control. The fuel cell (5.0 cm² geometric electrode area with single anode and cathode serpentine flow channels) was operated at either 60 or 80° C. with humidified air at atmospheric pressure and a flow rate of 500 sccm. The anode feed was either 0.5 or 1.0 M methanol.

MEAs were prepared with NAFION 117, nonstretched recast NAFION (annealed, with no elongation), and stretched recast NAFION using a two-layer catalyst structure for both the anode and cathode, with a total catalyst loading of 4 mg/cm² for each electrode. The first anode layer, 3.0 mg/cm² platinum-ruthenium alloy (1:1, Alfa Aesar) with 7 wt % NAFION ionomer (from a 5 wt % solution, Sigma-Aldrich), was painted (brushed) onto an A-6 ELAT/SS/NC/V2 carbon cloth. A second layer of PtRu (1.0 mg/cm² with 30 wt % NAFION ionomer) was brushed directly on the first. The two-layer cathode was made in a similar manner, using A-6 ELAT/SS/NC/V2 carbon cloth, where the first layer contained 3.0 mg/cm² Pt and 7 wt % NAFION ionomer and the second layer contained 1.0 mg/cm² and 40 wt % NAFION. Both the anode and cathode were dried at 80° C. for 30 min, annealed at 140° C. for 5 min, and then hot-pressed onto a membrane at 140° C. and 400 psi for 5 min. The MEAs were soaked in 1.0 M H₂SO₄ for 12 h and washed thoroughly with deionized water prior to a fuel cell test. A three-layer stretched recast NAFION MEA was made by placing one stretched recast NAFION membrane between two half-MEAs (made by hotpressing only one electrode to a recast film).

### Results and Discussion

It was reported in the literature that an elongated NAFION 117 membrane would relax back to its original shape upon immersion in an aqueous ethanol solution. Such relaxation behavior was confirmed when a uniaxially stretched NAFION 117 sample (draw ratio of 2) was soaked for 24 h in a hot (60° C.) aqueous methanol solution (75% methanol). For stretched recast NAFION membranes prepared according to the procedure outlined in the present example, no relaxation was observed after a similar hot methanol soak. Persistence of the morphology in stretched recast NAFION cannot be fully explained at the present time but is presumably due to the inclusion of the annealing step after stretching, where the creation of crystalline domains after elongation permanently fixed the stretched polymer morphology. Whereas recast NAFION prior to annealing is easy to stretch (because the polymer is primarily amorphous), the semicrystalline morphology of NAFION 117 makes this material difficult to elongate and prone to relaxation after swelling with mild heating.

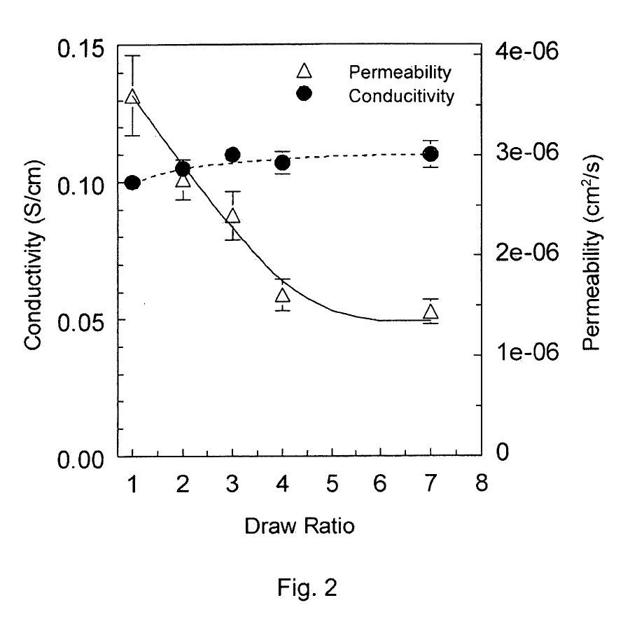

Proton conductivity and methanol permeability.—The through-plane proton conductivity (at 25° C.) and methanol permeability (1.0 M methanol at 60° C.) of stretched recast NAFION membranes is plotted against the draw ratio in FIG. 2. At a draw ratio of 1, (nonstretched recast NAFION), the conductivity (0.10 S/cm) was equal to that measured for a NAFION 117 sample. As the recast membrane was elongated to a draw ratio of 7, the conductivity rose slightly to a maximum value of 0.11 S/cm. The error bars on the conductivity data in FIG. 2 represent variations from multiple (three) measurements using different membrane samples. Within the accuracy of the experiments, in-plane and through-plane proton conductivities for stretched recast NAFION were the same. Whereas the proton conductivity was essentially unchanged with membrane elongation, the methanol permeability decreased from 3.6 to 1.44×10⁻⁶ cm²/s as the draw ratio increased from 1 (no stretching) to 7, although most of the change occurred for draw ratios≦4. The methanol permeability of unstretched recast NAFION was the same as that for commercial NAFION 117 (3.6×10⁻⁶ cm²/s). Permeability experiments were repeated 4-5 times at each draw ratio with different membrane samples to insure reproducibility (the error bars in FIG. 1 indicate the variation in permeability from multiple experiments). The maximum value of the relative selectivity of stretched recast NAFION (defined as the ratio of proton conductivity to methanol permeability as compared to the same ratio for NAFION 117) was 2.75 at a draw ratio≧4. Higher selectivities have been reported in the literature for other DMFC membranes, but the proton conductivity in such membranes was very low (which would require the use of very thin membranes in a fuel cell MEA). Typically, for an ionomeric DMFC membrane, a decrease in methanol permeability is accompanied by a reduction in proton conductivity, but this is not the case for stretched recast NAFION. In an attempt to explain this peculiar conductivity/permeability behavior, equilibrium water swelling (at 25° C.) and WAXD tests were performed.

Water swelling and WAXD.—Equilibrium membrane water uptake results are shown in Table I. As can be seen, there is only a small decrease in water sorption for stretched recast films, as compared to commercial NAFION 117, with the water uptake of the stretched samples independent of the draw ratio. Thus, there is no unusual membrane swelling behavior that might shed light on the results in FIG. 2.

TABLE 1
Equilibrium water uptake at 25° C. by
NAFION 117 and stretched NAFION
Swelling (wt %)

| Draw ratio | Recast NAFION | NAFION 117 |
|---|---|---|
| 1 (no stretching) | 32 | 35 |
| 2 | 31 | |
| 3 | 29 | |
| 3.5 | 30 | |
| 4 | 31 | |
| 7 | 30 | |

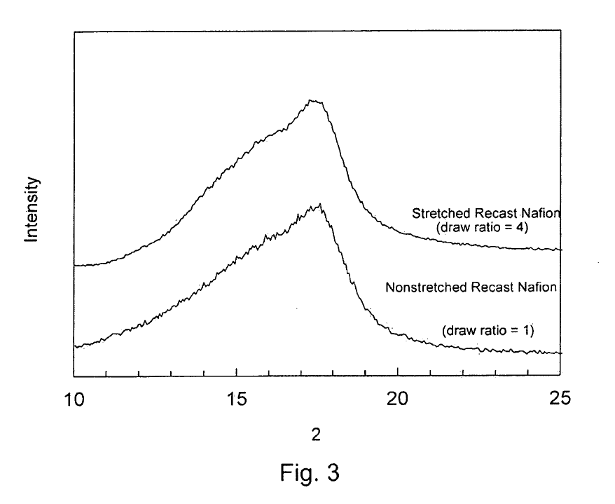

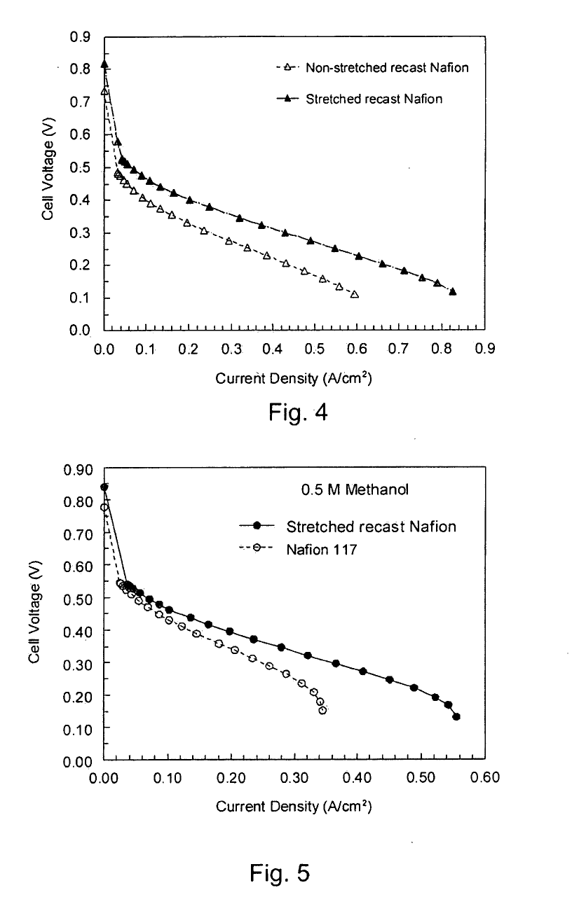

WAXD spectra of the stretched recast (draw ratio of 4) and nonstretched recast NAFION membranes for 2=10-25° is shown in FIG. 3. This region of the X-ray diffraction pattern contains the superposition of a crystalline peak (20=17.6°) and a broad amorphous halo centered around 20=15.9° (similar to that for commercial NAFION 117). These component profiles are usually not well-separated, making it difficult to perform a quantitative analysis of the degree of polymer crystallinity. It can be seen that the two spectra in FIG. 4 are nearly the same shape, indicating that stretching and then annealing of recast NAFION does not lead to a significant change in the membrane's crystalline morphology (i.e., no change in the degree of crystallinity or the size of crystallites). It cannot be precluded, however, that there is a preferred orientation of crystallites in the stretched films. Two-dimensional wide-angle X-ray scattering (WAXS) experiments are planned to probe more thoroughly the morphological consequences of stretching and then annealing recast NAFION. Additionally, small-angle X-ray scattering (SAXS) experiments will be performed to determine if there is a change in the hydrophilic ionic domain structure of stretched recast NAFION films. The results of both the WAXS and SAXS experiments will be the subject of a future publication.

Fuel cell performance.—Initial experiments sought to establish a clear difference between nonstretched recast and stretched recast NAFION in a DMFC. DMFC polarization plots for such membranes (a single 200 Mm thick nonstretched recast NAFION film with a draw ratio of 1 and a 180 μm thick stack of three stretched recast NAFION membranes with a draw ratio of 4) are shown in FIG. 4. Test conditions were 1.0 M methanol feed at 1.5 mL/min, 60° C., and ambient pressure air at 500 sccm. Fuel cell performance with recast NAFION was similar to data in the literature for commercial NAFION 117. For the stretched recast NAFION MEA, there was a significant improvement in power output, with a higher open-circuit voltage and a smaller V/I slope in the IR region of the polarization curve (i.e., less resistance losses due to the high conductivity and reduced thickness of the stretched recast NAFION MEA). As expected, the open-circuit methanol crossover flux with the stretched recast NAFION MEA (0.83×10⁻⁵ mol/cm²-min) was lower than that observed with nonstretched recast NAFION (1.25×10⁻⁵ mol/cm²-min) and was lower than that reported in the literature for a NAFION 117 MEA (1.0×10⁻⁵ mol/cm²-min). The higher crossover flux through the nonstretched recast NAFION MEA as compared to NAFION 117 is attributed to membrane thickness effects (the recast film was thinner). Next, the effect of methanol flow rate on DMFC performance was assessed for stretched recast NAFION (a three-layer stack) and NAFION 117, where the methanol feed concentration was either 0.5 or 1.0 M, the cell temperature was 60° C., and the air flow rate (at ambient pressure) was 500 sccm. For methanol flow rates between 1.0 and 16 mL/min, there was little (<10%) variation in power density at 0.4 V for NAFION 117 and stretched recast NAFION, with substantially higher power densities for MEAs with stretched recast NAFION. Thus, methanol flow rate effects on DMFC performance were not an issue that required further investigation.

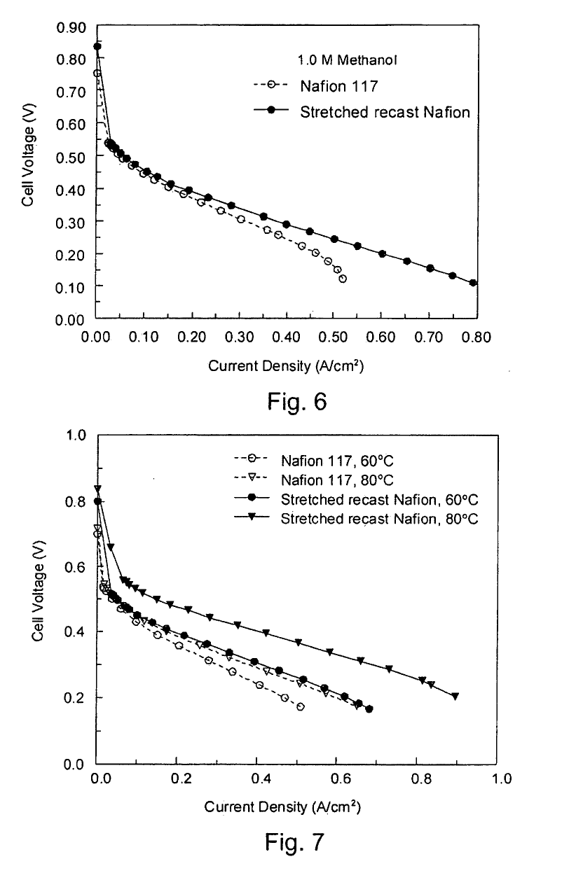

Voltage vs current density polarization plots for MEAs containing NAFION 117 and three layers of stretched recast NAFION are shown in FIGS. 5 and 6 for a 0.5 and 1.0 M methanol feed, respectively. A higher open-circuit voltage was obtained with stretched recast NAFION, which is consistent with the lower methanol permeability in this material. Better fuel cell performance under load was obtained with stretched recast NAFION, as compared to NAFION 117, due to the combined effects of lower methanol permeability and lower membrane sheet (areal) resistance. From current interrupt experiments, the ratio of MEA resistance with stretched recast NAFION, as compared to that with NAFION 117, was found to be proportional to the ratio of the membrane thicknesses (180 vs 215 μm), which is consistent with the membrane conductivity data in FIG. 2.

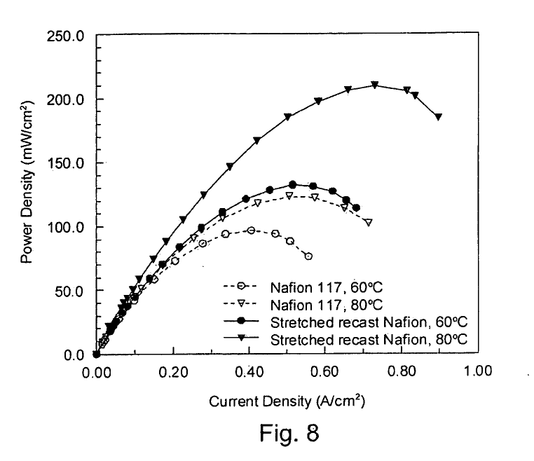

The effect of temperature (60 vs 80° C.) on DMFC polarization curves and power density plots for NAFION 117 and stretched recast NAFION is shown in FIGS. 7 and 8. For these experiments the methanol feed concentration was fixed at 1.0 M and the methanol flow rate was set at 1.5 mL/min. The superior performance of the stretched recast NAFION MEAs is obvious at both temperatures, but particularly so at 80° C. The increase in power density with cell temperature for a stretched recast NAFION MEA is far greater than that observed with NAFION 117. For stretched recast NAFION, the power density at 0.4 V more than doubled (162 vs 76 mW/cm²) and at 0.5 V increased by a factor of 3 (74 vs 25 mW/cm²) when the cell temperature was raised from 60 to 80° C. Further increases in power density are achievable by optimizing the electrode composition and MEA hotpressing conditions, increasing catalyst loading (some investigators use a loading as high as 8 mg/cm² for each electrode in a DMFC) and by applying backpressure to the cathode air. Such fuel cell experiments with stretched recast NAFION are in the planning stages.

### CONCLUSIONS

A method has been devised to fabricate uniaxially stretched recast NAFION membranes with a morphology that (i) is stable and does not change after exposure to hot methanol/water mixtures and (ii) restricts methanol permeation but does not affect (i.e., lower) proton conductivity. The key fabrication steps are the retention of some solvent in the recast film during stretching and the annealing of the film after stretching. Through-plane proton conductivity was essentially unchanged and methanol permeability decreased by a factor of 2.5 as the draw ratio was increased from 2 to 7. Such conductivity/permeability behavior is rarely, if ever, seen in a DMFC membrane (i.e., proton conductivity usually decreases with decreasing methanol permeability). MEAs with stretched recast NAFION membranes (draw ratio of 4) performed much better than NAFION 117 and nonstretched recast NAFION in a DMFC (at 60° C. with ambient pressure air and 4 mg/cm² each for the anode and cathode catalyst loading). With a 1.0 M methanol feed, the power density at 0.4 V with stretched recast NAFION (three films pressed together with a total thickness of 180 μm) was 38% higher than that with NAFION 117 (50% higher at 0.5 M methanol). At 80° C., the difference between stretched recast NAFION (draw ratio of 4) and NAFION 117 was even more pronounced. The maximum power density nearly doubled (209 vs 123 mW/cm² for NAFION 117) and the power output at 0.4 V was 2.3 times greater with a stretched recast membrane (162 vs 70 mW/cm² with NAFION 117).

Having described the invention we claim the following:

1. A proton exchange membrane comprising a semi-permeable polyelectrolyte film that extends along an axis, the polyelectrolyte film being stretched along the axis and remaining stretched when immersed in a methanol or methanol and water solution.

2. The proton exchange membrane of claim 1, the polyelectrolyte film having a first methanol permeability in an unstretched configuration and a substantially reduced methanol permeability in the stretched configuration.

3. The proton exchange membrane of claim 1, the polyelectrolyte film having a first proton conductivity in an unstretched configuration and a substantially equal or increased proton conductive in the stretched configuration.

4. The proton exchange membrane of claim 1, the polyelectrolyte comprising perfluorosulfonic acid polymer.

5. The proton exchange membrane of claim 1, the polyelectrolyte comprising a blend of polymers.

6. A method of forming a proton exchange membrane comprising:
forming a semi-permeable polyelectrolyte film that extends along a first axis;
stretching the polyelectrolyte film along the first axis, the stretched film remaining in a stretched configuration upon exposure to methanol.

7. The method of claim 6, the polyelectrolyte being formed by solution casting the polyelectrolyte film and partially drying the polyectrolyte film.

8. The method of claim 6, the polyelectrolyte film being annealed after stretching.

9. The method of claim 8, the polyelectrolyte film being activated after stretching.

10. A methanol fuel cell comprising:
an anode;
a cathode; and
a proton exchange membrane, the proton exchange membrane including a semi-permeable polyelectrolyte film that extends along an axis, the polyelectrolyte film being stretched along the axis and remaining stretched when immersed in a methanol or methanol and water solution.

11. The fuel cell of claim 10 being a direct methanol fuel cell.

12. The fuel cell of claim 10, the polyelectrolyte film having a first methanol permeability in an unstretched configuration and a substantially reduced methanol permeability in the stretched configuration.

13. The fuel cell of claim 10, the polyelectrolyte film having a first proton conductivity in an unstretched configuration and a substantially equal or increased proton conductive in the stretched configuration.

14. The fuel cell of claim 10, the polyelectrolyte comprising perfluorosulfonic acid polymer.

15. The fuel cell of claim 10, the polyelectrolyte comprising a blend of polymers.
